(19) United States
(12) Patent Application Publication
(10) Pub. No.: US 2016/0096696 A1
(43) Pub. Date: Apr. 7, 2016

(54) GAP BARRIER FOR DOCK LEVELERS

(71) Applicant: GLOBAL MATERIAL TECHNOLOGIES, INC., Buffalo Grove, IL (US)

(72) Inventor: David A. Colbert, Palatine, IL (US)

(73) Assignee: GLOBAL MATERIAL TECHNOLOGIES, INC., Buffalo Grove, IL (US)

(21) Appl. No.: 14/504,430

(22) Filed: Oct. 2, 2014

(51) Int. Cl. B65G 69/28; B32B 5/26; B32B 7/08; B32B 7/12; B32B 3/26; B32B 5/02

(52) U.S. Cl. CPC B65G 69/2876; B32B 3/263; B32B 5/022; B32B 7/08; B32B 7/12; B32B 5/028; B32B 5/26; B32B 2255/02; B32B 2255/26; B32B 2307/5825; B32B 2581/00

(57) ABSTRACT

The present invention provides an apparatus for covering a gap that is adjacent a side of a dock plate, which apparatus includes an elongate member having a top surface and a bottom surface, a pin connected to the bottom surface, a tear-resistant material in contact with the bottom surface of the elongate member; and a means for maintaining the contact between the tear-resistant material and the bottom surface.

### BACKGROUND OF THE INVENTION

The field of the present invention relates generally to building materials designed to retard or prevent entry of vermin into a structure through gaps attendant to a dock leveler in its resting, horizontal position.

The delivery of goods to a plant from tractor-trailers or trucks (referred to herein after as “trailers”) is facilitated by backing the trailer up to a loading dock of the plant. However, due to the lack of uniformity of trailers, no single-level loading dock can provide for the efficient and safe movement of goods from all trailers into the plant; more to the point, many trailers have bed heights that are either above or below the level of the loading dock. For that reason, loading docks are commonly outfitted with a dock leveler, which is a device used to raise or lower the distal end of the dock and thereby bridge the vertical gap between the dock and the trailer during loading and unloading. Dock levelers move a dock plate up or down to meet the trailer bed so that forklifts or other equipment, as well as persons, can make a smooth, safe transition into and out of the trailer.

To provide the reader with context for the present invention, a further description of a dock leveler 100 is provided in FIGS. 1A and 1B. As a general rule, using terms as usefully employed herein and the top view shown in FIG. 1A, a dock leveler is comprised of: (1) a dock plate 102 that includes (a) a distal end 101a that meets the bed of the openable end of a trailer (not shown) that has been maneuvered appropriately for delivery or pickup of goods, (b) two lateral sides 104, (c) a proximal end 103a that connects by way of one or more hinges (not shown) located at or about the edge where the plant floor 106 meets the proximal wall 110 of the pit 108; and (2) a raising/lowering mechanism (not shown) installed in the pit 108 and connected to the underside of the dock plate 102 that serves to cause the distal end 101a of the dock plate 102 to meet the trailer bed.

Typically, the plant's outside walls 107a and 107c extend on either side of the dock opening. As noted, the dock plate 102 is attached at or about its inside or proximal edge 103a (proximal, that is, with respect to the interior of plant) to a hinging mechanism (not shown) that permits pivoting up or down of the distal end of the dock per the action of the aforementioned raising/lowering mechanism. As shown in FIG. 1B, the side edges 104 of the dock plate 102 can be seen to form an acute angle between the side edges 104 and the resting, horizontal position of the dock plate (shown as a dash line that is substantially coplanar to the plant's floor 106). The dock plate 102 is caused to pivot up or down as a function of a mechanism (not shown) that is installed in the pit 108 as part of the dock leveler 100. When not in use, the dock plate 102 is typically placed into a horizontal position relative to the interior floor 106, and a door (not shown) closes off the dock from the outside, which door is usually located proximal to the outside walls of the plant (shown as triplicate lines where the middle line is thicker than either of the outer lines, i.e., [symbol] ). Other surfaces or edges shown in FIGS. 1A and 1B include: the edge of the dock plate 102 (the edge of which is labeled with numeral 104 and drawn with a heavy line, i.e., [symbol] ); and the edge of any hard surface, such as concrete, is represented by a duplicate line, i.e., [symbol] , as indicated for the interior surfaces 110 and 111 of the dockleveler pit 108 and the dock floor 106.

To permit that upward or downward movement for the functioning of the dock leveler 100, there typically is a gap 109a or 109b between the side edges 104a and 104c of the dock plate 102 and the side edges 105a and 105b of the pit 108 (also referred to here as the lateral pit walls (i.e., the pit walls that are orthogonal to the outside wall 107b)). Accordingly, both heat and vermin can enter or leave the plant by way of the pit 108 and the aforementioned gap despite having closed off the dock with the aforementioned door. This is particularly the case for those pits that include cracks that permit air flow and access to vermin or where the outer boundary 105c1 of the pit 108 is not enclosed. Also, as further described below, gaps may also be presented along the back wall of the pit where the dock plate is hinged. Unless the gaps are closed, heat will leave the plant in the winter and enter in the summer; and, irrespective of season, vermin will enter the plant; it is this flow of air and/or vermin that forms the central rationale for having undertaken the effort to find better means for closing off the flow, and which is the subject of the instant application.

Vermin naturally seek shelter and food, so it is a fair bet that they will head indoors given the opportunity. The term vermin relates to animals considered to be pests, including but not limited to rodents, such as rats, mice, squirrels, and the like. Other sorts of vermin include snakes and arachnids of all sorts, but notably insects, spiders, and scorpions. Particularly when the outside becomes cold and/or wet, and the vermin on the spot has a desire to seek the heat and dry environs of the interior of a building, synthetic or rubber or bristle strips may present a challenge but not a lasting one; and far less so if the vermin senses a food prize in the interior as well. Food prizes are certain to be found in plants dedicated to housing, processing, or selling foodstuffs. No currently used mechanism for closing off the gaps found in dock levelers has been shown to be uniformly and lastingly effective.

A needed improvement to currently available closures of gaps in dock levelers is therefore needed. The inventive concept set forth herein below answers this need.

### SUMMARY OF THE INVENTION

The present invention provides an apparatus and a method of use thereof that answers the needed improvement in currently available approaches and materials therefor for sealing a dock leveler with respect to entry of vermin or exchange of heat.

In particular, the present invention relates to an apparatus for covering a gap that is adjacent a side of a dock plate, which apparatus includes (i) an elongate member having a top surface and a bottom surface; (ii) a pin connected to the bottom surface; (iii) a tear-resistant material in contact with the bottom surface of the elongate member; and (iv) a means for maintaining the contact between the tear-resistant material and the bottom surface. In one embodiment of the invention, the apparatus has a length that approximates the length of the lateral side of the dock plate. In a second embodiment, the apparatus further includes a sealing material in contact with the tear-resistant material. In a third embodiment, the sealing material is rubber or plastic; and can comprise a polymer of one or more monomers selected from the group consisting of vinylchloride, ethylene, and vinyl acetate.

The tear-resistant material of the present invention comprises a metal. In a fourth embodiment, the metal is in the form of metal fibers. The metal fibers can have a rough barbed outer surface with irregularly shaped cross-sections that vary along their respective lengths in certain embodiments. In a fifth embodiment, the tear-resistant material is a composite nonwoven fabric comprising an interengaged mixture of metal fibers and nonmetal fibers.

In a sixth embodiment, the means for maintaining the contact between the tear-resistant material and the bottom surface is selected from the group consisting of a first adhesive, a rivet, a screw, a weld, and a hook. In a seventh embodiment, the present invention can further include a second adhesive disposed between the tear-resistant material and the sealing material.

And in an eighth embodiment, the present invention further includes a screen disposed between the tear-resistant material and the sealing material, wherein the screen is comprised of a metal.

In a ninth embodiment of the present invention, the apparatus further includes a third adhesive disposed between two portions of the tear-resistant material. And in a tenth embodiment, the present invention further includes a fourth adhesive disposed between the screen and the tear-resistant material, wherein the first adhesive layer or the second adhesive layer or the third adhesive layer or the fourth adhesive layer is comprised of a pressure sensitive adhesive.

In an eleventh embodiment, the present invention relates to an apparatus for covering a gap that is adjacent a side of a dock plate, which, upon said gap being covered by said apparatus, results in substantially impeding movement of fluid or vermin through said gap, which apparatus includes (i) a sealing material, (ii) a tear-resistant material that is adjacent to the sealing material, wherein the tear-resistant material comprises metal, (iii) an elongate member having a top surface and a bottom surface, and (iv) one or more connecting materials for connecting the sealing material to the tear-resistant material and the tear-resistant material to the elongate member.

In a twelfth embodiment, the elongate member includes at least one pin attached to its bottom surface; the metal is in the form of a sheet or metal fiber; and the metal fiber has a cross sectional diameter of between about 25 microns and about 150 microns.

In a thirteenth embodiment, the inner material comprises (a) a first layer of metal fibers; (b) a mesh layer that includes a top side and a bottom side; and (c) a second layer of metal fibers; wherein the first layer of metal fibers and the second layer of metal fibers each include a plurality of barbed projections and a rough barbed outer surface with irregular shaped cross-sections that vary along the lengths of the metal fibers and wherein further the metal fibers interengage with each other; and wherein the first layer of metal fibers is needle punched to the mesh layer on the top side and the second layer of metal fibers is needle punched to the mesh layer on the bottom side; wherein, in certain embodiments, the first layer of metal fibers has a basis weight of between about 800 g/m² and about 2400 g/m², and the inner material comprises a composite nonwoven fabric that comprises an interengaged mixture of metal fibers and nonmetal fibers.

In a fourteenth embodiment, the present invention relates to a method for excluding vermin or weather from entry into the interior of a building by way of a gap located at a side of a dock plate when the dock plate is placed in a horizontal position, which method comprises the steps of: (i) providing the apparatus described with reference to the first embodiment of the invention and (ii) placing the apparatus over the gap such that the pin or pins insert into the gap.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A is a top view of a dock leveler.

FIG. 1B is a side view of a dock leveler.

FIG. 2A is a top view of one embodiment of the gap sealer of the present invention.

FIG. 2B is a side view of one embodiment of the gap sealer of the present invention.

FIG. 2C is a bottom view of one embodiment of the gap sealer of the present invention.

FIG. 3A is an enlarged perspective view of one of the metal fibers of the metal fabric displayed in FIG. 3B.

FIG. 3B is a perspective view of the metal fabric.

FIG. 4A depicts a magnified perspective view of a crimped nonmetal fiber useful in providing the composite nonwoven fabric employed in one embodiment of the invention.

FIG. 4B depicts a magnified perspective view of the metal fibers of the composite nonwoven fabric of the invention.

FIG. 4C is a magnified sectional view of the composite nonwoven fabric of the invention showing the random arrangement of the metal and nonmetal fibers.

FIG. 5A is a cross-sectional view of one embodiment of the exclusion fabric.

FIG. 5B is a cross-sectional view of another embodiment of the exclusion fabric.

FIG. 5C is an enlarged perspective view of metal fibers used in the exclusion fabric employed in some of the embodiments of the present invention.

### DETAILED DESCRIPTION OF THE INVENTION

The present invention relates to an apparatus that functions to preclude or retard entry of air flow or vermin at the gaps commonly associated with a dock leveler system installed in a loading dock. The apparatus is referred to herein as a “gap barrier”.

Descriptions provided herein refer to the attached drawings, in which same structures in different figures are generally (but not necessarily) labeled with the same numeral. Of course, one skilled in the art can readily make variations on these descriptions, which variations are considered to be part and parcel of this disclosure.

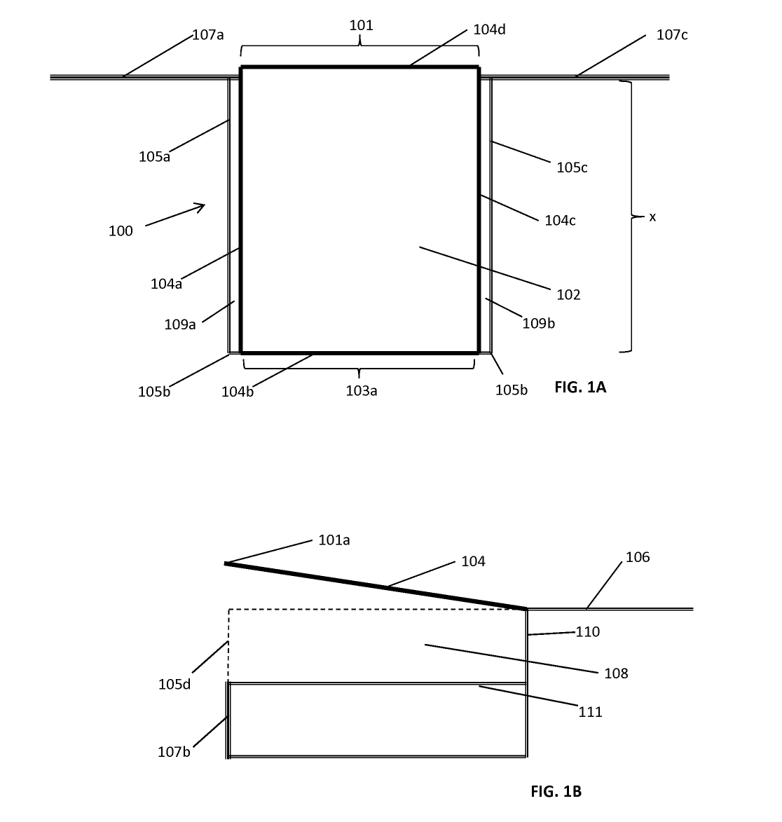

Dock leveler systems come in many varieties and designs. Using FIGS. 1A and 1B, one general description is provided here to lend context to the way the gap barrier of the present invention is employed; it is important to note that the gap barrier is employable for any dock leveler system currently in use, many of which may depart from that described here. Generally, a dock leveler system includes a pit 108 located centrally in a loading dock area, where the pit is about six feet to about seven feet wide, about eight feet to about 10 feet long and about 18 inches to about 24 inches deep. The tops of the three interior sides of the pit end at edges 105a, 105b, and 105c, respectively, where they meet the dock floor 106. A raising/lowering mechanism (not shown) is installed in the pit 108. A dock plate 102 substantially covers the opening to the pit 108, which dock plate 102 is attached to the top edge 104b at the interior wall of the pit by one or more hinges (not shown) as well as to the raising/lowering mechanism at a point or points that are distal to the top edge 104b. The exterior side of the pit 102 can be open to the elements or enclosed by a retractable boundary to allow the dock plate to meet a truck bed that is lower than the typical dock height of about 48 inches (relative to the outside ground accessed by vehicles). (Truck or trailer bed heights range from as low as about 19 inches up to about 55 inches.)

The raison d'\check{e}tre of the gap barrier is provided by the fact that in order for the dock plate 102 to be able to pivot up or down, there must be a gap between the lateral edges 104a and 104c of the dock plate 102 and the edges 105a and 105c of the pit 102, respectively. Also, if the hinge or hinges that connect the dock plate 102 to the back end of the pit do not cover the entire width of the dock plate, then there will also be a gap along the dock plate at its hinged end. These gaps along two or all of the interior sides of the dock plate can be less than an inch thick or as wide as several inches, either extreme of which provides ample opportunity for entry by vermin and weather.

The issue of the necessary gaps in a dock leveler system is generally not an issue for a dock when it is under active use because human activity serves to deter entry by vermin and the degree that the gaps contribute to heat loss or heat gain pale compared to other potential heat transfer points of an active loading dock. But, when the dock is idle and, typically, no persons are present, a door is used to seal off the outer opening of the loading dock between outer walls 107a and 107b, thus most points of heat exchange are closed off. Loading docks are generally left in a horizontal, resting position for hours when the plant served by the dock is closed or a scheduled non-delivery period is enforced.

Nonetheless, there is not insignificant potential for heat transfer and highly significant potential for vermin entry by way of the gaps between the dock plate and the dock floor as described above. Accordingly, especially for loading docks that serve a food-based business, such gaps must be blocked; but all business structures can provide food and shelter to vermin and can suffer heat loss or heat gain resulting in unnecessarily added operating cost, so the utility of the present invention is clearly understandable.

Generally speaking, the gap barrier is usefully employed during said off hours by incorporating placement of the gap barrier over gaps located between the dock plate and the dock floor as commonly occur between any or all of the three sides 104a, 104b, 104c of the dock plate 102 that are adjacent the floor of the dock (which floor is labeled with numeral 106 and extends away from the dock pit 108 at edges 105a and 105c). As noted above, the hinged proximal side 104b of the dock plate 102 may or may not include a gap between the dock plate 102 and the dock floor 106, depending commonly on whether or not the hinge or hinges used extend the entire width 103a of the dock plate 102, as could be the case when using a piano hinge, for example. If the hinge or hinges are co-extensive with the dock plate width, then it is highly unlikely that vermin enter the dock area at the proximal side 104b; but if the hinge or hinges that are employed do not cover all parts of the dock plate width, then it is likely that one or more gaps exist through which vermin may enter. The lateral sides 104a and 104c of the dock plate, however, nearly always have a gap between them and the respective edges 105a and 105c of the dock floor, thus creating gaps 109a and 109b. The length x of a dock plate can vary with the particular design of dock leveler installed into a dock, but is generally between about 8 feet and about 10 feet.

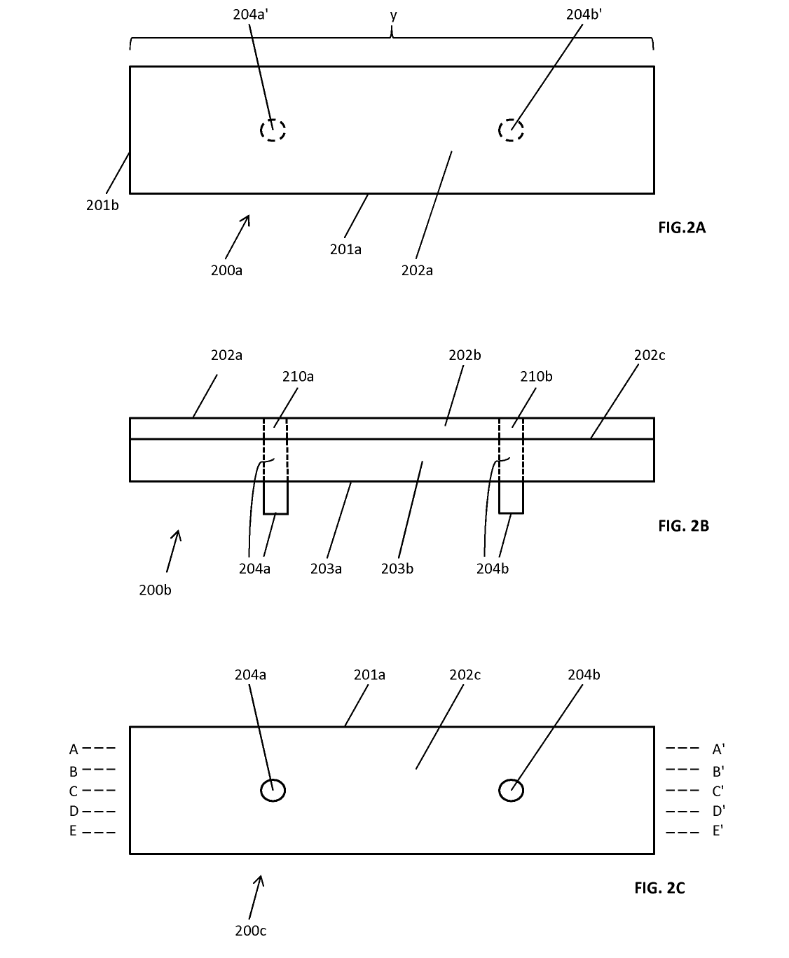

The structure of the gap barrier of the present invention is shown in FIGS. 2A, 2B, and 2C. FIG. 2A depicts a top view 200a of the gap barrier having an elongate member 202 that has a short edge 201b and a long edge 201a, where the length y is commonly six feet or eight feet or 10 feet, but can also be four feet or five feet. In one embodiment, the gap barrier is cut to accommodate the length of a given gap found with respect to a particular dock leveler system; accordingly, with respect to gaps found along the lateral sides of a dock plate, such gap barriers are about six feet long or about eight feet long or about ten feet long; and, with respect to gaps found along the proximal side of the dock plate 102 that is hinged to the inside-most wall of the dock pit 108, such gap barriers are about six feet long or about seven feet long or about eight feet long. Whatever the actual length of a particular gap, the gap barrier can be cut using a simple hacksaw or any other saw appropriate for cutting flat stock metal.

The width of the elongate member is generally between about three inches and about five inches, and in certain embodiments is about four inches. The depth of the elongate member is generally between about one-eighth (⅛) inch and about one-half (½) inch; in certain embodiments, the elongate member has a depth of between about one-eighth (⅛) inch and three-eighths (⅜) inch; and in yet other embodiments, the elongate member has a depth of about one-quarter (¼) inch. The top surface 202a of the elongate member is generally smooth.

The gap barrier of the present invention can include positioning pins, such as those indicated in FIG. 2B by numerals 204a and 204b. Positioning pins serve to hold the gap barrier directly above the gap by resisting lateral movement of it relative to the gap itself. The pins are continuous from their respective distal ends to their respective points of attachment to the elongate member at their respective proximal ends (where the pins are drawn with a dashed line to indicate where they are obscured by the tear-resistant material 203 and flat stock used to form elongate member 202 used in one embodiment). In some embodiments, there is only a single pin per length of the gap barrier; and in other embodiments, there are two pins as shown in FIG. 2; in yet other embodiments, more than two pins are included in a length of the gap barrier.

Preferably, when a length of the gap barrier includes a single pin, then the embodiment also includes a mechanism for securing one length of the dock gap material to its adjoining length of dock gap material.

In one embodiment, the gap barrier includes an elongate member 202 whose long side 201a has a length y that is substantially longer than its short side 201b. In this embodiment, the length y is substantially the same length as those of the lateral sides of the dock plate 102 shown in FIG. 1A. Accordingly, placement of the gap barrier 200a shown in FIG. 2A over the gap 109a or 109b serves to seal the entire gap and preclude or retard inward movement of vermin or weather.

In another embodiment, length of the gap barrier (determined by the length of its included elongate member) is less than x such that one must apply multiple dock gap barriers to seal the gap 109a or 109b. Such embodiments where the elongate member has a length that is less than that of the gap requiring closure optionally include an end-to-end closure mechanism on the top surface (indicated by position 202a on the elongate member shown in FIG. 2A) and/or the side surface (indicated by position 201b) for binding the short end of one elongate member to its adjoining elongate member, using, for example, hook and eye metallic or plastic closures or hook and loop materials (typical of that sold under the Velcro® tradename) or magnetic closures or other simple mechanisms well known in the art.

The present invention in one embodiment uses two or more standard lengths of the gap barrier that are each less than the length x of the lateral sides of a dock plate; and may also be less than the width of a dock plate. In this embodiment, a combination of the standard lengths of the gap barriers are placed end to end along the length of a gap, including each lateral side of a dock plate. In a related embodiment to this one, end-to-end closures are included for each standard length so that when placed upon the gap, the entire length of the gap barriers are bound one to the other. In another such embodiment, the standard lengths include a 4-foot length and foot-length varieties; the 4-foot length varieties can include one or two pins and the foot length includes a single pin; in yet another such embodiment, the pins are placed generally toward an end of each standard length.

The top surface may show the position of positioning pins that protrude orthogonally from the bottom surface of the elongate member at positions 204a′ and 204b′. In certain embodiments, holes for insertion of the proximal ends of pins 204a and 204b can be seen from the top surface at the stated locations. The positioning pins can be viewed in the cross-sectional view 200b of the gap barrier shown in FIG. 2B. In different embodiments, the positioning pin is connected to the elongate member 202 by insertion into a hole drilled of equal diameter until the proximal end of the positioning pin is approximately flush with the top surface of the elongate member, at which point the positioning pin is welded such that the insertion becomes permanent. In other embodiments, the positioning pin is threaded at its proximal end and a hole of equal diameter is tapped with complementary threading, whereupon the threaded positioning pin is screwed into the elongate member. In some embodiments, the so-screwed in positioning pin is also welded. The diameter of the positioning pins 204a and 204b can range from about one-eighth (⅛) inch to about five-eighths (⅝) inch; from about one-quarter (¼) inch to about one-half (½) inch; and, in one embodiment, the diameter of the positioning pins is one-quarter (¼) inch or one-half (½) inch.

The elongate member itself can be manufactured from any substantially inflexible material whose weight and inflexibility will facilitate its function to keep vermin or weather from coming through the dock gap 109a or 109b or that associated with the proximal side 104b of the dock plate 102. Accordingly, the elongate member can be any suitably stiff material, such as a metal, ceramic, plastic, or the like. In one embodiment, the elongate member is composed of galvanized or stainless steel or epoxy-stabilized ceramic. In certain embodiments, the elongate member and the positioning pins comprise metal and, more particularly, comprise steel. Yet more particularly, in certain embodiments, the elongate member and positioning pins comprise a galvanized steel or a stainless steel.

As shown in FIG. 2B, pins 204a and 204b extend from their respective distal ends, where they are represented with a solid line, through a tear-resistant material 203b up to respective holes 210a and 210b. From the point that the tear-resistant material 203b begins along surface 203a, and through the two noted holes drilled into the flat stock 202, the positioning pins are represented by a dash line because they are obscured from view by the tear-resistant material and the flat stock.

The gap barrier includes a tear-resistant material that, in one embodiment, is, at least in part, inserted into the gap; in another embodiment, in contact with both surfaces of the two adjoining areas, i.e., the dock floor and the dock plate; and, in a third embodiment, in contact with both of said surfaces as well as inserted into the gap. As is discussed further below, one alternative embodiment of the present invention includes contact of the tear-resistant material only at the gaps; however, this approach is less attractive when the width of the gap in a particular dock leveler installation varies within and/or between sides thereof.

The positioning of the tear-resistant material on the gap barrier can vary between different embodiments of the present invention. Different embodiments of the present invention include different widths and placements of the tear-resistant material connected to the bottom surface of the elongate member 202. Referring to FIG. 2C showing the bottom side of the gap barrier 200c, one embodiment of the present invention includes strips of the tear-resistant material that are affixed to the bottom surface between the top edge or the line A---A′ or B---B′ and the line D---D′ or E---E′ or the bottom edge, provided that the tear-resistant material is disposed to cover or, in part, be inserted into the dock gap with the tear-resistant material. Alternatively, for other embodiments, strips of the tear resistant fabric can be affixed in row pairs that cover or are disposed on opposing sides of the dock gap, such as, for example, strips defined substantially by the top edge of the elongate plate and the line A---A′ or B---B′ and the bottom edge and the line D---D′ or E---E; in such embodiments, the ends of each pair of strips of tear-resistant material are preferably connected by an additional strip of tear-resistant material thereby fully enclosing the area of potential access sought by vermin.

The tear-resistant material 203 is preferably a metal or metal-containing substance, such as a metal sheet, a metal screen, a metal fabric comprised of metal wire or fibers, woven or non-woven, or a composite metal/nonmetal fabric comprised of metal and nonmetal wire or fibers, woven or non-woven. Such materials are described herein below as well as in co-owned U.S. Pat. Nos. 5,972,814, 6,249,941, 6,298,538, 6,502,289, 6,583,074, and 6,919,117, each of which are incorporated herein in their entireties by reference. The nonwoven metal fabrics identified herein and usefully employed for the tear-resistant material can be obtained from Global Materials Technologies, Inc. (“GMT”) of Chicago, Ill., which employs methods of manufacture as disclosed in the aforementioned patents.

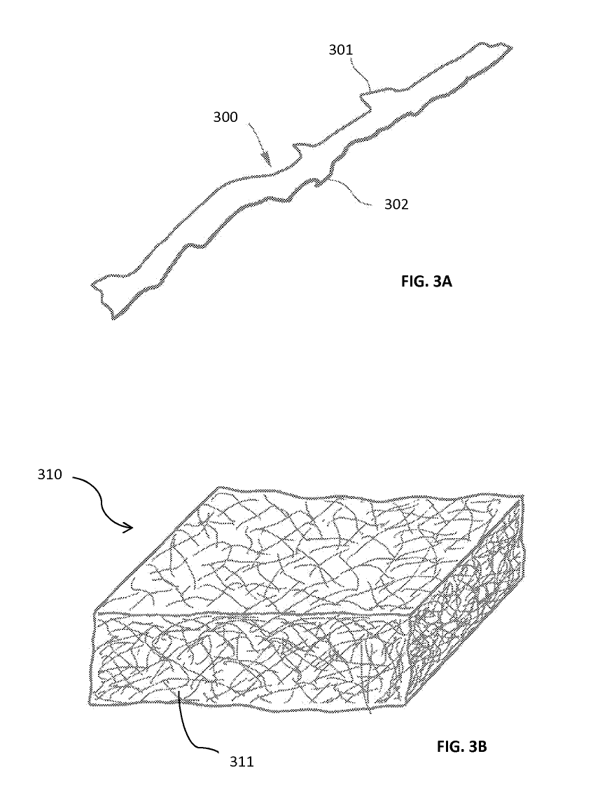

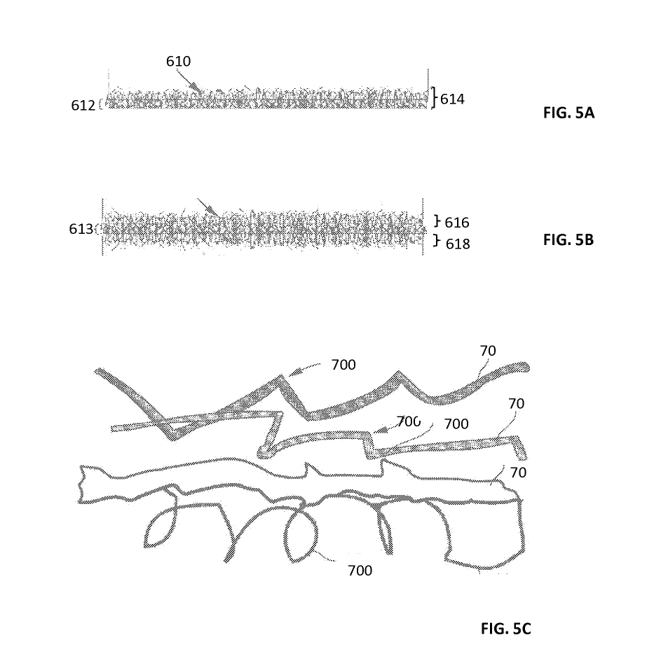

One of the components of the tear-resistant material as displayed in FIGS. 3A, 3B, 4A, 4B, 4C, 5A, 5B, and 5C is indeed the just-mentioned metal fibers. Turning to FIG. 3A, which displays a single metal fiber 300 having variable width cross-section and barbs, see e.g., numerals 301 and 302, a useful tear-resistant material comprises a mass or batt of such metal fibers 300 (FIG. 3A) and 70 (FIG. 5C). These metal fibers include a random irregular cross-section and rough outer surfaces with barb projections 700 and 301 formed on the outer surfaces. The irregular cross-sections vary continuously along the length of the resulting fibers to provide generally curled metal fibers. The curled and barbed nature of the metal fibers allows strong interengagement and intertwining with each other and the mesh layer (for those embodiments that include a mesh layer, also referred to as a scrim layer). In one embodiment, the metal fibers 70 are produced by shaving a metal member with a succession of serrated blades, as disclosed in commonly assigned U.S. Pat. Nos. 6,249,941 and 5,972,814, which are incorporated by reference. The succession of serrated blades has a variety of different serration patterns, so that the resulting individual fibers have barbed projections 700 and irregular cross sections with rough outer surfaces.

In certain embodiments, the metal fibers are shaved from a metal wire. For example, the metal fibers 70 can be produced by shaving a metal member with a succession of serrated blades, as disclosed in commonly assigned U.S. Pat. Nos. 6,249,941 and 5,972,814. The succession of serrated blades has a variety of different serration patterns, so that the resulting individual fibers have barbed projections 700 and irregular cross sections with rough outer surfaces. A suitable lubricant, such as oil, is applied to the metal member as it is being shaved by the blades in sufficient quantity so that the metal fibers retain on their outer surface a carding-effective amount of the oil or lubricant.

Overall, the metal fibers used in the context of the present invention have a cross sectional diameter of between about 10 microns and about 250 microns in one embodiment, in another embodiment between about 25 microns and about 125 microns, and in yet another embodiment between about 50 microns and about 100 microns. The metal fiber can be any suitable metal fiber having characteristics of position memory, such as, for example, an aluminum, bronze, copper, nickel, iron, steel or stainless steel metal fiber. In another embodiment, a suitable metal fiber is not only characterized with position memory but, as well, has substantial resistance to oxidation, such as, for example, a stainless steel or aluminum metal fiber.

Generally speaking, in certain embodiments hereof, the tear-resistant material includes a layer of metal fibers that has a basis weight of between about 200 g/m² and about 4000 g/m², alternatively between about 800 g/m² and about 2400 g/m², or, in yet a third alternative, between about 1000 g/m² and about 2000 g/m².

“Carding-effective amount” of oil or lubricant means that the metal fibers, when blended with the nonmetal fibers, can be carded without substantial breakage or disintegration. The lubricant optionally may be applied after the metal fibers are formed. The commonly assigned U.S. Pat. No. 5,972,814 discloses the process for shaving a metal bar to produce lubricated metal fibers and the use of such lubricated metal fibers. A carding-effective amount of oil generally may be in the range of about 0.3 wt. % to about 1.0 wt. % oil, more preferably about 0.4 wt. % to about 0.7 wt. %, based on the total weight of the metal fibers, although lesser or greater amounts may be used depending on the type and average cross-sectional length and width of the metal fibers. For example, as the weight percentage of metal fibers is decreased, the quantity of oil or lubricant necessary to provide a carding effective amount may tend to increase. Conversely, as the weight percentage of metal fibers increases, this reduces the quantity of oil needed for carding without breakage of the metal fibers. Thus, a carding-effective amount of oil for carding various combinations and amounts of metal fibers can be determined on a case-by-case basis.

Preferably, the metal fibers are made from any metal; for applications where rust and corrosion is appropriately retarded, stainless steel can be used. The metal fibers 70 can also be made from bronze, carbon steel, copper, metal alloys, and other suitable metals that can be shaved into suitable metal fibers to suit a variety of pest deterring gap barrier applications. The metal fibers can have an average cross sectional length, width, or height of between about 25 and about 125 microns.

Another form of a metal fabric usefully employed in the context of the present invention is shown in FIGS. 5A and 5B. In one embodiment, as shown in FIG. 5A, a metal fabric 610 generally comprises a layer 614 of an interengaged mixture of a plurality of metal fibers 300 and a mesh layer 612, wherein the layer 614 of metal fibers is needle punched to the scrim layer to form the metal fabric 610.

In another embodiment, the metal fabric 610 comprises an interengaged mixture of a plurality of metal fibers 300, as shown in FIG. 3A. The metal fabric 610 generally comprises a layer 616 of metal fibers, a mesh layer 613 including a first side, for instance, a top side, and a second side, for instance, a bottom side; and a second layer 618 of metal fibers, wherein the first layer 616 of metal fibers is needle punched to the mesh layer on the first, or top, side and the second layer 618 of metal fibers is needle punched to the mesh layer on the second, or bottom, side to form a metal fabric 610 that is commonly referred to as an exclusion fabric (as indeed all of the metal fabrics noted herein are called due to their capacity to exclude vermin).

With regard to the simpler metal fabric 310 displayed in FIG. 3B, the metal fibers 300 are interengaged and intertwined and thus provide a density and resiliency for excluding pests in any environment.

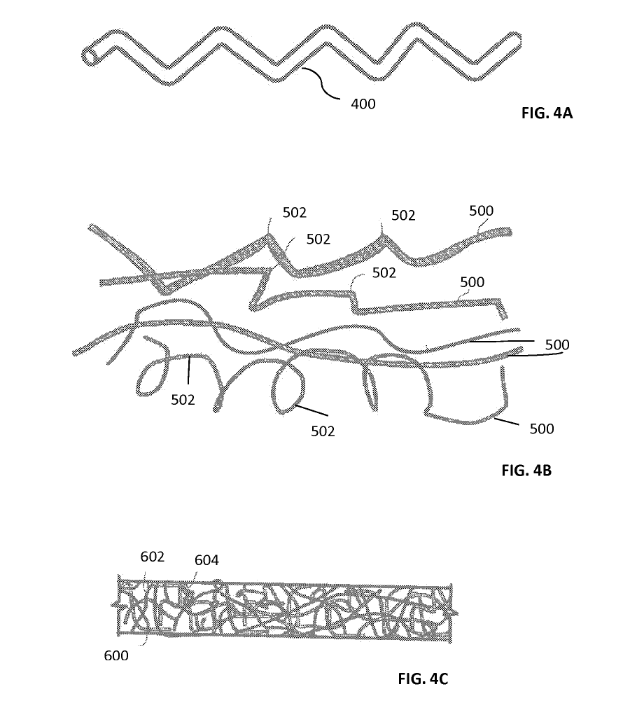

Yet another metal fabric usefully employed for the gap barriers of the present invention also includes nonmetal fibers, as shown in FIG. 4. A nonmetal fiber 400 of the type used in forming a composite (i.e., metal and nonmetal) nonwoven fabric employed in some embodiments of the present invention, is shown in FIG. 4A; this nonwoven fabric is a tear-resistant material. Such fibers may be essentially any synthetic or natural staple fibers conventionally used in the textile industry for making nonwoven fabric material, such as polypropylene, polyester, polyethylene, rayon, nylon, acetate, acrylic, cotton, wool, olefin, amide, polyamide, fiberglass and the like. The lengths of the nonmetal fibers may be from about one inch to about 12 inches, and are, in many embodiments of the present invention, less than about six inches in length. A common current method for manufacture of the present invention includes using nonmetal fibers having length from about one inch to about three inches. The nonmetal fibers may be cut to size by conventional means. The nonmetal fibers are less brittle than the metal fibers, and are generally unaffected by the carding process.

The grade of the nonmetal fibers may range from about one denier to about 120 denier, more preferably from about 10 denier to about 80 denier and most preferably about 18 denier to about 60 denier. In general, the metal fibers will have an average cross-sectional diameter that is from about one-half to about two-times the cross-sectional diameter of the nonmetal fibers. More preferably, the metal fibers and nonmetal fibers will have similar average diameters and lengths. In one embodiment, the composite nonwoven fabric comprises synthetic polymer fibers, such as polyester or polypropylene fibers, having a grade of about 60 denier and metal fibers having an average cross section of about 60 microns.

Crimped synthetic fibers having a repeating “V” shape along their length such as that shown in FIG. 4A, are known in the art. Crimped synthetic fibers having about 3 to 10 “V” shaped crimps per inch are usefully employed as the nonmetal fibers in the composite nonwoven fabrics of one embodiment of the present invention; for example, crimped fibers having about 7 crimps per inch were used in manufacture of one such embodiment. Of course, a greater or lesser degree of crimping may be selected as the particular application demands. Such crimped synthetic fibers are generally employed because they are readily carded by a garnett or carding machine.

The composite nonwoven fabric employed in the context of certain embodiments of the gap barrier invention discussed herein has a ratio of metal fibers to non-metal fibers of between about 10:1 and about 1:99, by weight. In one embodiment, the composite nonwoven fabric comprises about 75 to about 95 wt. % metal fibers and about five to about 25 wt. % nonmetal fibers, in another embodiment about 85 to about 92 wt. % metal fibers and, in yet another embodiment, about eight to about 15 wt. % nonmetal fibers.

As will be appreciated by those skilled in the art, metal fibers are several fold denser than nonmetal fibers—that is the specific gravity of metal fibers is substantially greater than the specific gravity of synthetic fibers and other nonmetal fibers. Accordingly, it will be understood that composite nonwoven fabric may have relatively similar numbers of metal fibers and nonmetal fibers, even though, on a weight percent basis, the composite nonwoven fabric is mostly metal.

It will also be appreciated by the person having ordinary skill in the art that “denier” is a measure of specific weight (or fineness) of a fiber that is arrived at by weighing a predetermined length of the fiber. (One denier equals 0.05 grams per 450 meters). Accordingly, different nonmetal fabrics having the same denier may have different cross-sectional diameters.

In several embodiments of the present invention, the tear-resistant material is a nonwoven material comprised of metal and synthetic fibers that is referred to as an exclusion fabric. This particular tear-resistant material, namely the exclusion fabric, is the subject of co-assigned U.S. patent application Ser. No. 13/051,318, filed Mar. 18, 2011, which is incorporated by reference herein. As more fully disclosed in the '318 application, FIG. 4A-C depicts a cross section of two different such fabrics that have the nonwoven blend of metal fibers 500 and synthetic fibers 400. Also shown is a blow-up of the jagged metal fibers 300 in FIG. 3A.

In one embodiment, the plurality of metal fibers 20 is shown in FIG. 9C. The metal fibers 20 include a random irregular cross-section and rough outer surfaces with barb projections 200 formed on the outer surfaces. The irregular cross-sections vary continuously along the length of the resulting fibers to provide generally curled metal fibers. The curled and barbed nature of the metal fibers allows strong interengagement and intertwining with each other and the mesh layer. In one embodiment, the metal fibers 20 are produced by shaving a metal wire with a succession of serrated blades, as disclosed in commonly assigned U.S. Pat. Nos. 6,249,941 and 5,972,814, which are hereby incorporated by reference. The succession of serrated blades has a variety of different serration patterns, so that the resulting individual fibers have barbed projections 200 and irregular cross sections with rough outer surfaces.

A suitable lubricant, such as oil, is preferably applied to the metal member as it is being shaved by the blades in sufficient quantity so that the metal fibers retain on their outer surface a carding-effective amount of the oil or lubricant. “Carding-effective amount” of oil or lubricant means that the metal fibers, when blended with the nonmetal fibers, can be carded without substantial breakage or disintegration. The lubricant optionally may be applied after the metal fibers are formed. The commonly assigned '814 patent discloses the process for shaving a metal bar to produce lubricated metal fibers and the use of such lubricated metal fibers. A carding-effective amount of oil generally may be in the range of about 0.3 to 1.0 wt. % oil, more preferably about 0.4 to 0.7 wt. %, based on the total weight of the metal fibers, although lesser or greater amounts may be used depending on the type and average diameter of the metal fibers. For example, as the weight percentage of metal fibers is decreased, the quantity of oil or lubricant necessary to provide a carding effective amount may tend to increase. Conversely, as the weight percentage of metal fibers increases, this reduces the quantity of oil needed for carding without breakage of the metal fibers. Thus, a carding-effective amount of oil for carding various combinations and amounts of metal fibers can be determined on a case-by-case basis. Preferably, the metal fibers are made from stainless steel, as to prevent rusting and corrosion of the exclusion fabric. However, the metal fibers 20 can also be made from bronze, carbon steel, copper, metal alloys, and other suitable metals that can be shaved into suitable metal fibers to suit a variety of pest deterring applications. The metal fibers can have an average cross sectional diameter of between about 25 microns and about 125 microns.

Reels of metal fibers are made from individual strands of metal fibers, which are gathered together. When the metal fibers are shaved with the serrated knives, individual strands of metal fibers are produced. The individual strands of metal fibers from various serrated knives or blades are gathered together and processed through a set of rolls to flatten and form a web of fibers of a certain width and weight. The width of the web of metal fibers can vary from about one inch wide to about 12 inches wide depending on the weight of the web of metal fibers desired. The web of metal fibers is then rolled up into a reel that can be further processed. The weight of the web of metal fibers is determined by the weight per two foot length of the web of metal fibers. To keep a consistent metal wool reel, the weights of the reel webs stay consistent throughout the length and width of the metal wool reel. The metal wool reels are used to a wider roll of material when lined up side by side. The metal wool reels may have a basis weight between about 800 g/m² to about 2400 g/m².

The mesh layer 14 may be an open woven mesh layer, a spunbonded adhesive fiber mesh ply, a nylon mesh layer, or a polyester mesh layer, or a nonwoven material. The mesh can be made up of various materials, such as polyester, polypropylene, nylon, polyvinylchloride (“PVC”), or any number of other suitable materials that allows for needle punching the metal wool reels on the top and bottom sides. The mesh provides added strength to the geotextile in both the x-direction and the y-direction. Then with the needle punching of the metal fibers through the top and bottom sides of the mesh layer, the exclusion fabric will have the strength in the z-direction. The basis weight of the mesh layer may vary from 90 g/m² to about 500 g/m², depending on the type of mesh layer used. The mesh layer in one embodiment may include a basis weight of about 90 g/m². Mechanical bonding of the mesh layer can be hydro-entanglement, air-jet entanglement, needle punching, needle stitching, or by any other mechanical bonding method known in the art that may increase the strength of the mesh layer for z-directional strength during needle punching the top and bottom sides of the mesh layer with metal fibers. In one example, the polyester mesh ply can have a basis weight of 120 g/m².

As noted above, a usefully employed inner material can comprise a composite web material of metal and nonmetal fibers formed into an integrated matrix structure. The metal fibers preferably have rough outer surfaces that are irregular in cross-section with barbed projections. The nonmetal fibers are preferably crimped synthetic fibers. The intertwined mix of metal and nonmetal fibers comprising a nonwoven fabric employed in the context of the present invention provides surprising isotropic strength and structural integrity to the fabric and, as well, the inventive apparatus described herein.

The composite nonwoven fabrics employed in the context of the present invention comprise metal fibers having an average cross-sectional diameter of from about 25 microns to about 125 microns, or more, and preferably have an average diameter of about 50 microns to about 100 microns, more preferably have an average diameter of about 70 microns to about 90 microns; and, overall, in one embodiment are about 80 microns to about 90 microns. Fibers greater than about 50 microns in diameter are stronger. Thus, the use of metal fibers having an average diameter greater than about 50 microns strengthens the composite nonwoven fabrics and, thus, strengthens the gap barriers of the present invention. The barbs and irregular surfaces of the metal fibers provide the composite non-woven fabric a desired abrasive quality that deters vermin, and helps maintain the interentanglement of the fibers. Variables that can be controlled include the size of the fibers and the weight ratios between the metal and nonmetal fibers used in the product.

If desired, the exclusion fabric, or another metallic inner material usefully employed in the context of the present invention, may optionally include various additives, such as insect repellents and animal repellents, which may enhance the performance of the inventive apparatus as a vermin deterrent.

Attachment of the tear-resistant material 203b to the bottom surface 202c of the elongate member 202 can be accomplished using any suitable adhesive, that is an adhesive capable of adhering to metals. Usefully employed such adhesives include, without limitation intended, Scotch-Weld brand neoprene adhesive (3M, St. Paul, Minn.), Thixon or Megon brand adhesives (Rohm & Haas, Philadelphia, Pa.), and rubber-metal adhesive GMK 2410 (Weicon GmbH & Co. KG, Munster, Germany). Pressure-sensitive adhesives are also suitable adhesives for this purpose, including, without limitation, acrylics, butyl rubber, ethylene vinyl acetate, nitriles, silicone rubbers, styrene-butadiene-styrene, and the like. Mechanical means can be used instead or in addition, such as by use of screws, rivets, welds, hooks attached to the bottom surface 202c that engage the tear-resistant material 203b, and the like.

An alternative embodiment of the present invention (not shown) includes a rubber or synthetic seal disposed on the outer surface 203a of the tear-resistant material, which surface faces the respective surfaces of the dock floor and dock plate when employed. The outside surface when comprised of rubber or a suitable synthetic forms a substantially air-tight seal with the dock plate and dock floor when the gap barrier is placed over the gap. The outer surface 203a when formed of a synthetic is commonly formed from a synthetic that has characteristics of rubber, which synthetic may include, without limitation, polyvinylchloride, polyethylene, vinyl acetate, polyester, and the like; or polymers that combine two or more monomers described for the just-identified synthetics. Any suitable polymer will suffice for the role to the extent that the suitable polymer exhibits similar rubber characteristics of flexibility and tackiness, i.e., the ability to adhere reversibly to a surface, especially a concrete or metal surface.

When preparing the dock for business hours, the gap barrier of the present invention can be placed to the side of the working dock area along the floor by the lateral walls of the dock. Alternatively, the gap barrier of the present invention can be placed onto a shelf in the dock area or near thereto; or placed onto a specially-designed mounting structure for holding said gap barrier (or units thereof) safely.

Gaps 109a and 109b that permit free entry of fluids or vermin or both at the lateral sides 104 of the dock plate 102 of a dock leveler assembly commonly are part of the design of that assembly, necessarily included to allow the distal end 101a of the dock plate to raise or lower as needed without being impeded by the sides of the dock pit. The gap barrier of the present invention is designed to address such gaps by reliably maintaining a close connection between the lateral sides of the dock plate and the respective edges of the dock floor 105 adjacent to the edges of the lateral sides of the dock leveler pit 108 where the dock plate is placed when in its resting position. The present invention closes these gaps despite the inevitable destructive acts of vermin wanting to enter. Of course, all materials eventually decay, and the inventive apparatus is no exception. But, unlike prior art dock leveler seals, the inventive varieties set forth herein below retain their ability to frustrate the majority of vermin attempts to enter a building for an extended period of time and, with proper use, will not be sheared or otherwise damaged by the ordinary and appropriate action of the dock leveler or the maneuvering of a delivery trailer or truck.

One of the surprising aspects of the present invention, however, is that even without an outer surface that is tacky or gripping, as is the case in other embodiments described herein that include the tear-resistant material per se as the point of contact with the dock plate and dock floor, the seal there-between is nonetheless substantially air-tight providing a highly effective barrier to both vermin and weather.

Of course, any artisan will recognize that the better-sealing barrier will preferably include the rubber or synthetic outer layer. Given our general understanding of vermin that when confronted with an impenetrable barrier as represented by the tear-resistant material of the present invention (further described herein below) after having gnawed through a portion of the outer rubber or synthetic seal, they will generally go off and seek an entirely different entry point (if not an entirely different goal). That is a notable result in view of the fact that vermin, especially mice and rats, are known for their ability to gnaw through rubber and synthetic barriers when motivated by the prospect of food or shelter, but even upon having done so, the gap barrier that includes the rubber or synthetic outer layer will continue to present a substantially air-tight seal against both the elements and vermin.

A gap barrier that includes a metal layer or, even better, a cuttingly sharp metal layer serves to discourage even the most intrepid of vermin. Such a gap barrier can be an apparatus that connects an edge of a dock plate to an adjoining surface (such as a floor at the top of a dock leveler pit); or, better yet, connects all the edges of the dock plate that are adjacent a gap to the adjoining floor. When the edges of the dock plate and the adjoining floor are wholly connected by such an apparatus, vermin seeking entry are substantially impeded from doing so as is any fluid from the outside. Simply put, neither fluid nor animals can readily gain entry about the edge of a resting, horizontal dock plate to which the gap barrier of the present invention has been applied, as described herein.

Of course it is plainly the case that a gnawing animal can damage the outer material as set forth herein; however, upon reaching the inner material and/or, if present, the screen as employed in the present invention, the gnawing animal will stop. Gnawing at metal screens or metal or metal fabric is not an easy path and is highly likely to dissuade the vermin. Neither will they succeed by tearing at the metal fabric in view of the highly interengaged fibers included therein. But, that leaves a damaged outer material, which can be repaired with a patch applied with an appropriate adhesive or heat fusion method, as known in the art.

While preferred embodiments of the present invention have been shown and described herein, it will be obvious to those skilled in the art that such embodiments are provided by way of example only. Numerous variations, changes, and substitutions will now occur to those skilled in the art without departing from the invention or the definitions provided herein for clearly recording inventor's conception and embodiments thereof. It should be understood that various alternatives to the embodiments of the invention described herein may be employed in practicing the invention.

It is intended that the following claims define the scope of the invention and that methods and structures within the scope of these claims and their equivalents be covered thereby.

What is claimed is:

1. An apparatus for covering a gap that is adjacent a side of a dock plate, which apparatus comprises:
(i) an elongate member having a top surface and a bottom surface;
(ii) a pin connected to the bottom surface;
(iii) a tear-resistant material in contact with the bottom surface of the elongate member; and
(iv) a means for maintaining the contact between the tear-resistant material and the bottom surface.

2. The apparatus of claim 1, wherein the apparatus has a length that approximates the length of the lateral side of the dock plate.

3. The apparatus of claim 1, further comprising a sealing material in contact with the tear-resistant material.

4. The apparatus of claim 3, wherein the sealing material is rubber or plastic.

5. The apparatus of claim 4, wherein the sealing material comprises a polymer of one or more monomers selected from the group consisting of vinylchloride, ethylene, and vinyl acetate.

6. The apparatus of claim 1, wherein the tear-resistant material comprises a metal.

7. The apparatus of claim 6, wherein the metal is in the form of metal fibers.

8. The apparatus of claim 7, wherein the metal fibers have a rough barbed outer surface with irregularly shaped cross-sections that vary along their respective lengths.

9. The apparatus of claim 7, wherein the tear-resistant material is a composite nonwoven fabric comprising an interengaged mixture of metal fibers and nonmetal fibers.

10. The apparatus of claim 1, wherein the means for maintaining the contact between the tear-resistant material and the bottom surface is selected from the group consisting of a first adhesive, a rivet, a screw, a weld, and a hook.

11. The apparatus of claim 10, further comprising a second adhesive disposed between the tear-resistant material and the sealing material.

12. The apparatus of claim 1, further comprising a screen disposed between the tear-resistant material and the sealing material, wherein the screen is comprised of a metal.

13. The apparatus of claim 12, further comprising a third adhesive disposed between two portions of the tear-resistant material.

14. The apparatus of claim 13, further comprising a fourth adhesive disposed between the screen and the tear-resistant material.

15. The apparatus of claim 14, wherein the first adhesive layer or the second adhesive layer or the third adhesive layer or the fourth adhesive layer is comprised of a pressure sensitive adhesive.

16. An apparatus for covering a gap that is adjacent a side of a dock plate, which, upon said gap being covered by said apparatus, results in substantially impeding movement of fluid or vermin through said gap, which apparatus comprises:
(i) a sealing material;
(ii) a tear-resistant material that is adjacent to the sealing material, wherein the tear-resistant material comprises metal;
(iii) an elongate member having a top surface and a bottom surface; and
(iv) one or more connecting materials for connecting the sealing material to the tear-resistant material and the tear-resistant material to the elongate member.

17. The apparatus of claim 16, wherein the elongate member includes at least one pin attached to its bottom surface.

18. The apparatus of claim 16, wherein the metal is in the form of a sheet or metal fiber.

19. The apparatus of claim 18, wherein the metal fiber has a cross sectional diameter of between about 25 microns and about 150 microns.

20. The apparatus of claim 19, wherein the inner material comprises (a) a first layer of metal fibers; (b) a mesh layer that includes a top side and a bottom side; and (c) a second layer of metal fibers; wherein the first layer of metal fibers and the second layer of metal fibers each include a plurality of barbed projections and a rough barbed outer surface with irregular shaped cross-sections that vary along the lengths of the metal fibers and wherein further the metal fibers interengage with each other; and wherein the first layer of metal fibers is needle punched to the mesh layer on the top side and the second layer of metal fibers is needle punched to the mesh layer on the bottom side

21. The apparatus of claim 20, wherein the first layer of metal fibers has a basis weight of between about 800 g/m² and about 2400 g/m².

22. The apparatus of claim 21, wherein the inner material comprises a composite nonwoven fabric that comprises an interengaged mixture of metal fibers and nonmetal fibers.

23. A method for excluding vermin or weather from entry into the interior of a building by way of a gap located at a lateral side of a dock plate when the dock plate is placed in a horizontal position, which method comprises the steps of:
(i) providing the apparatus of claim 1; and
(ii) placing the apparatus over the gap such that the pin or pins insert into the gap.
